(19) United States
(12) Patent Application Publication
(10) Pub. No.: US 2013/0282699 A1
(43) Pub. Date: Oct. 24, 2013

(54) Using Authority Website to Measure Accuracy of Business Information

(71) Applicants: Gang Feng, Beijing (CN); Bo Zheng, Beijing (CN); Fang Chu, Beijing (CN); Dylan Myers, Seattle, WA (US)

(72) Inventors: Gang Feng, Beijing (CN); Bo Zheng, Beijing (CN); Fang Chu, Beijing (CN); Dylan Myers, Seattle, WA (US)

(73) Assignee: GOOGLE INC., Mountain View, CA (US)

(21) Appl. No.: 13/977,917

(22) PCT Filed: Jan. 14, 2011
(86) PCT No.: PCT/CN2011/070254

§ 371 Date: Jul. 1, 2013

(51) Int. Cl. G06F 17/30

(52) U.S. Cl. CPC G06F 17/3053
USPC 707/722; 707/748

(57) ABSTRACT

Business information about business entities are received from a plurality of aggregate information sources such as business directories. An authority page of a business entity is retrieved and information is extracted from the authority page. The extracted information is compared with business information about the business entity from the aggregate information sources. Accuracy scores are generated for the combination of the business entity and the aggregate information sources based on the comparison results. A collection of accurate business information for the business entity is generated by including business information from aggregate information sources with high accuracy scores.

### BACKGROUND

1. Field of Disclosure

The disclosure generally relates to the field of data processing, in particular to measuring data accuracy.

2. Description of the Related Art

Information about business entities is available from aggregate information sources such as business directories. The quality of the business information varies drastically from source to source. In addition, the quality of business information from one particular aggregate information source also varies from category to category (or from region to region). Currently, the accuracy of business information provided by an aggregate information source is measured primarily based on human belief in the source. This approach is both unreliable and over-general. Accordingly, what is needed is a way to reliably measure the accuracy of business information provided by an aggregate information source.

### SUMMARY

Embodiments of the present disclosure include methods (and corresponding systems and computer program products) for measuring the accuracy of business information from aggregate information sources using information extracted from authority websites and generating collections of accurate business information based on the accuracy measurements.

One aspect of the present disclosure is a computer-implemented method for generating accurate business information, comprising: retrieving business information about a plurality of business entities from one or more aggregate information sources; retrieving an authority page from an authority website of one of the plurality of business entities; comparing business information about said business entity retrieved from the one or more aggregate information sources with information extracted from the authority page for a comparison result; generating an accuracy score for a combination of said business entity and one of said aggregate information sources based at least in part on the comparison result; and generating a collection of accurate business information for said business entity based at least in part on the accuracy score.

Another aspect of the present disclosure is a computer system for generating accurate business information, comprising: a non-transitory computer-readable storage medium comprising executable computer program code for: retrieving business information about a plurality of business entities from one or more aggregate information sources; retrieving an authority page from an authority website of one of the plurality of business entities; comparing business information about said business entity retrieved from the one or more aggregate information sources with information extracted from the authority page for a comparison result; generating an accuracy score for a combination of said business entity and one of said aggregate information sources based at least in part on the comparison result; and generating a collection of accurate business information for said business entity based at least in part on the accuracy score.

A third aspect of the present disclosure is a non-transitory computer-readable storage medium storing executable computer program instructions for generating accurate business information, the computer program instructions comprising instructions for: retrieving business information about a plurality of business entities from one or more aggregate information sources; retrieving an authority page from an authority website of one of the plurality of business entities; comparing business information about said business entity retrieved from the one or more aggregate information sources with information extracted from the authority page for a comparison result; generating an accuracy score for a combination of said business entity and one of said aggregate information sources based at least in part on the comparison result; and generating a collection of accurate business information for said business entity based at least in part on the accuracy score.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a high-level block diagram of a computing environment according to one embodiment of the present disclosure.

FIG. 2 is a high-level block diagram illustrating an example of a computer for use in the computing environment shown in FIG. 1 according to one embodiment of the present disclosure.

FIG. 3 is a high-level block diagram illustrating modules within a business information management server according to one embodiment of the present disclosure.

FIG. 4 is a flow diagram illustrating a process for measuring the accuracy of business information from aggregate information sources using information extracted from authority websites and generating accurate business information based on the accuracy measurements, according to one embodiment of the present disclosure.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### Computing Environment

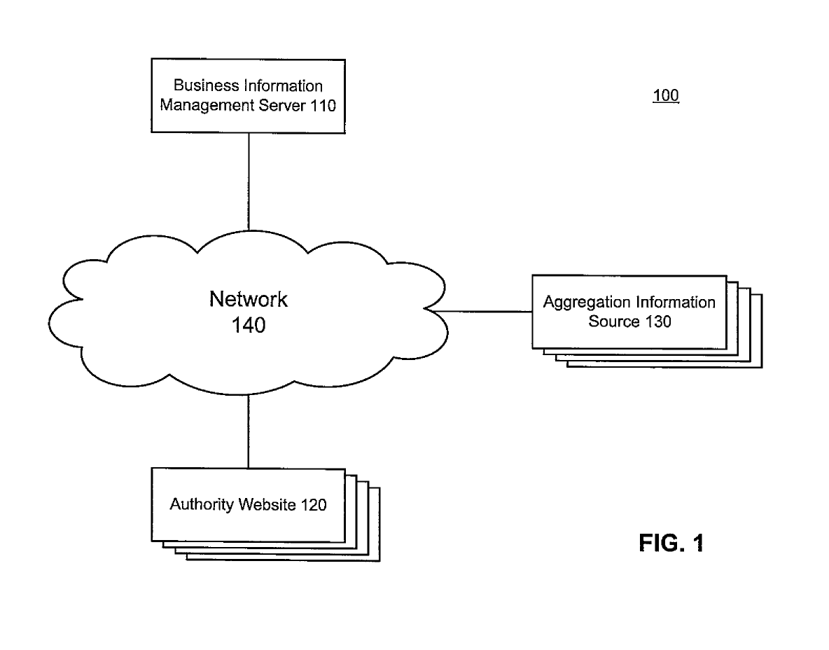

FIG. 1 is a high-level block diagram that illustrates a computing environment 100 for measuring the accuracy of business information from aggregate information sources using information extracted from authority websites and generating collections of accurate business information based on the accuracy measurements, according to one embodiment of the present disclosure. As shown, the computing environment 100 includes a business information management server 110, authority websites 120, and aggregate information sources (also called “sources”) 130, all connected through a network 140. There can be other entities in the computing environment 100.

The authority websites 120 are the official websites (also called “home websites”) of business entities. An authority website of a business entity includes one or more web pages (also called “authority pages”, “home pages”) containing information about the business entity, and is typically created and/or managed by the business entity. An authority website 120 can be identified by a Uniform Resource Locator (“URL”) that specifies a domain (e.g., www.domain.com), a subdomain (e.g., www.domain.com/subdomain/) in which the authority pages are hosted, or an authority page (e.g., www.domain.com/authorityPage.html). Because the authority websites 120 are directly controlled by the corresponding business entities, information on the authority pages is generally accurate and up-to-date, and thus is more trustworthy comparing to information about the business entities provided by the aggregate information sources 130. In fact, the authority websites 120 often are the sources of information about the corresponding business entities for the aggregate information sources 130.

The aggregate information sources 130 provide business information about various business entities. The business information includes business names, telephone numbers, addresses, business hours, and values of other attributes. Examples of the aggregate information sources 130 include business directory websites and business review websites. The aggregate information sources 130 gather the business information from sources such as government records, the authority websites 120, and user inputs.

The business information management server 110 retrieves business information about various business entities from multiple aggregate information sources 130, measures the accuracy of the business information based on the authority websites 120 of the business entities, and consolidates the retrieved business information into accurate business information based on the accuracy measures. In order to measure the accuracy of business information about a business entity, the business information management server 110 visits the authority website 120 of that business entity, extracts information from authority pages in the authority websites 120, and compares the extracted information with the business information retrieved from the aggregate information sources 130. The business information management server 110 generates collections of accurate business information for the various business entities based on the accuracy measurements. In one embodiment, the business information management server 110 provides a web-based business search functionality that provides users with accurate business information of business entities in search results.

The network 140 enables communications among the business information management server 110, the authority websites 120, and the aggregate information sources 130. In one embodiment, the network 140 uses standard communications technologies and/or protocols. Thus, the network 140 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 140 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 140 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 140 can also include links to other networks such as the Internet.

### Computer Architecture

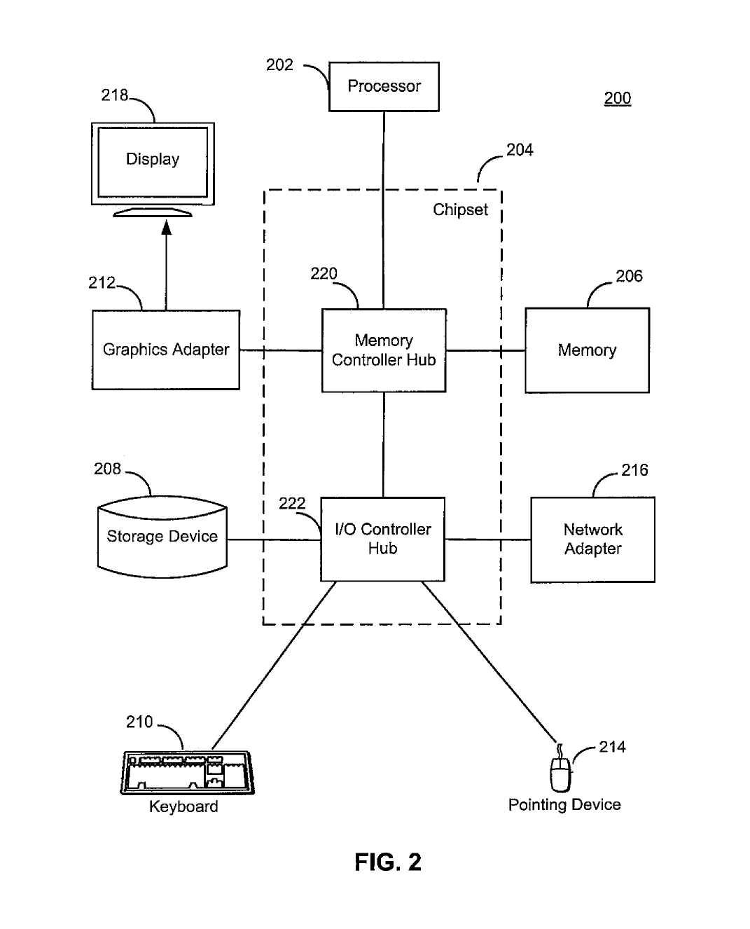

The entities shown in FIG. 1 are implemented using one or more computers. FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the 110 controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers 200 used by the entities of FIG. 1 can vary depending upon the embodiment and the processing power required by the entity. For example, the business information management server 110 might comprise multiple blade servers working together to provide the functionality described herein. The computers 200 can lack some of the components described above, such as keyboards 210, graphics adapters 212, and displays 218. In addition, one or more of the functions of the business information management server 110 can also be executed in a cloud computing environment. As used herein, cloud computing refers to a style of computing in which dynamically scalable and often virtualized resources are provided as a service over the Internet.

### Example Architectural Overview of the Business Information Management Server

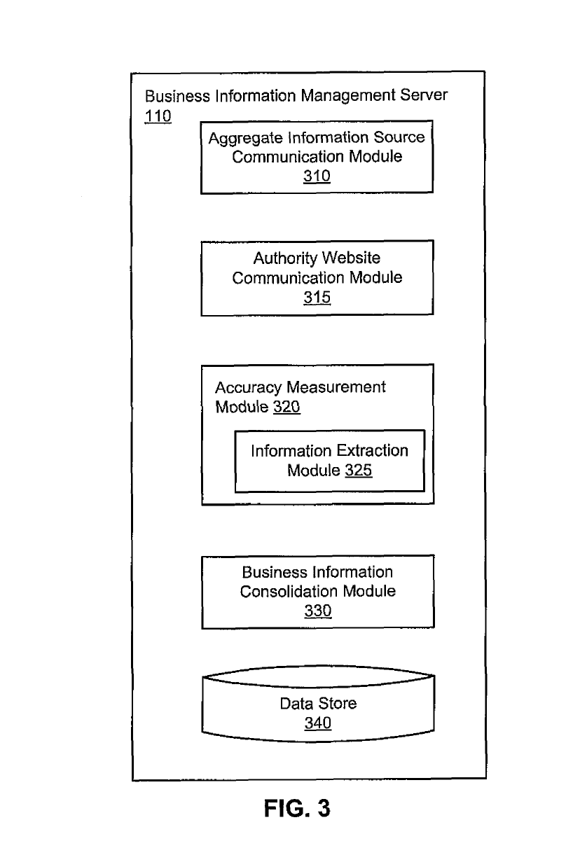

FIG. 3 is a high-level block diagram illustrating a detailed view of modules within the business information management server 110 according to one embodiment. Some embodiments of the business information management server 110 have different and/or other modules than the ones described herein. Similarly, the functions can be distributed among the modules in accordance with other embodiments in a different manner than is described here. As illustrated, the business information management server 110 includes an aggregate information source communication module 310, an authority website communication module 315, an accuracy measurement module 320, a business information consolidation module 330, and a data store 340.

The aggregate information source communication module 310 communicates with multiple aggregate information sources 130 to retrieve business information about various business entities. Additionally or alternatively, the aggregate information source communication module 310 receives the business information from the aggregate information sources 130 (e.g., uploaded by the aggregate information sources 130 to a website hosted by the aggregate information source communication module 310).

The authority website communication module 315 communicates with the authority websites 120 to retrieve authority pages. The authority website 130 of a business entity is provided by the aggregate information sources 130 (e.g., as a part of the business information about the business entity) or determined based on factors such as web pages in search results of a query for the business entity. The authority website communication module 315 retrieves the authority pages by traversing the authority website 130.

The accuracy measurement module 320 measures the accuracy of business information retrieved from the sources 130. The accuracy measurement module 320 generates a trustworthy score that measures the overall trustworthiness of each source 130, and an accuracy score that measures the accuracy of business information about a particular business entity retrieved from each source 130. For example, the trustworthy score can be a continuous value ranging from 0 to 1, which a score of 0 indicating a very low trustworthiness (e.g., the business information from the source 130 is probably inaccurate) and a score of 1 indicating a very high trustworthiness (e.g., the business information from the source 130 is almost certainly accurate). Similarly, the accuracy score can be a continuous value ranging from 0 to 1, which a score of 0 indicating a very low accuracy (e.g., the business information is probably inaccurate) and a score of 1 indicating a very high accuracy (e.g., the business information is almost certainly accurate).

The accuracy measurement module 320 measures the accuracy of business information about a business entity retrieved from the sources 130 by comparing the business information with information extracted from authority pages of that business entity. Because the authority websites 120 are directly controlled by the corresponding business entities, information extracted from the authority pages is very likely to belong to the corresponding business entities and more accurate comparing to the business information about the business entities provided by the aggregate information sources 130. Accordingly, the extracted information can be used to measure the accuracy of the corresponding business information (e.g., telephone numbers, addresses) from the aggregate information sources 130. As shown in FIG. 3, the accuracy measurement module 320 includes an information extraction module 325.

The information extraction module 325 extracts information from authority pages retrieved by the authority website communication module 315 from the authority websites 120. Example information extracted by the information extraction module 325 in authority pages includes telephone numbers and addresses. The information can be extracted from authority pages such as the welcome page (also called a “default page”) of the authority website 130 and the web page directed to by hyperlinks labeled “contact us” or similar text in other authority pages (also called a “contact page”). The information extraction module 325 extracts the telephone number and the address using technologies such as pattern matching, tag recognition, and/or natural language processing.

To measure the accuracy of business information about a business entity retrieved from a source 130 (also called a “entity-source pair”), the accuracy measurement module 320 compares the information extracted from the authority pages of the business entity to corresponding business information retrieved from the source 130, and calculates an accuracy score for the entity-source pair. For example, if the information extraction module 325 extracts a telephone number from the authority website 130 of a business entity, the accuracy measurement module 320 compares the extracted telephone number with the telephone number(s) of that business entity provided by each source 130. If the telephone number from a source 130 matches the extracted telephone number, the accuracy measurement module 320 assigns a high accuracy score for the entity-source pair (or increases a previously assigned accuracy score). Alternatively, if the telephone number from a source 130 mismatches the extracted telephone number, the accuracy measurement module 320 assigns a low accuracy score for the entity-source pair (or decreases the previously assigned accuracy score). If multiple pieces of information (e.g., telephone number, address) are extracted, the accuracy scores reflect comparisons of all extracted information. The accuracy measurement module 320 may normalize the information to be compared (e.g., removing symbols such as “(”, “)”, “−” from telephone numbers, converting uppercase characters in addresses into corresponding lowercase characters) before conducting the comparisons.

The accuracy measurement module 320 generates a trustworthy score for each source 130 based on the accuracy scores of entity-source pairs including that source 130. The trustworthy score can be a combination of the accuracy scores (e.g., average, mean, or median). In addition to using the extracted information to measure the accuracy of business information provided by sources 130, the accuracy measurement module 320 may add the extracted information into the collection of business information about the business entities (e.g., if no source 130 provides matching business information).

The business information consolidation module 330 consolidates business information about various business entities from the aggregate information sources 130 into collections of accurate business information about such business entities. For attribute values of a business entity that are extracted from the authority pages of that business entity (e.g., phone number, address), the business information consolidation module 330 deems the extracted attribute values accurate and includes in the collection of accurate business information for that business entity. For other attributes, the business information consolidation module 330 includes the attribute values from the sources 130 with the highest accuracy scores for that entity-source pair in the collection. For a business entity with no known authority website 120 (or no authority website 120 can be determined), the business information consolidation module 330 uses the trustworthy scores for the aggregate information sources 130 as the accuracy measures of the business information, and includes attribute values about that business entity from the sources 130 with the highest reputation scores in the collection.

The data store 340 stores data used by the business information management server 110. Examples of such data include the collections of accurate business information for various business entities, the business information retrieved from the aggregate information sources 130, authority pages retrieved from the authority websites 120, information extracted from the authority pages, accuracy scores, and trustworthy scores, to name a few. The data store 340 may be a relational database or any other type of database.

### Overview of Methodology for the Business Information Management Server

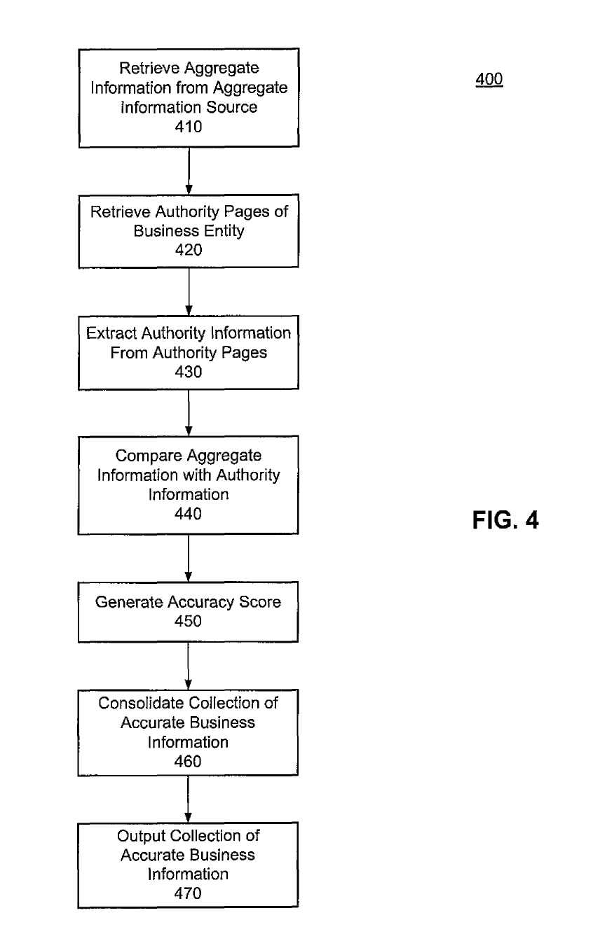

FIG. 4 is a flow diagram illustrating a process 400 for the business information management server 110 to measure the accuracy of business information from the aggregate information sources 130 using information extracted from the authority websites 120, and generate collections of accurate business information based on the accuracy measurements, according to one embodiment. Other embodiments can perform the steps of the process 400 in different orders. Moreover, other embodiments can include different and/or additional steps than the ones described herein.

The business information management server 110 retrieves (or receives) 410 business information of various business entities from the aggregate information sources 130. For example, for a restaurant named “Crazy Guidos”, the business information management server 110 retrieves 410 related business information from two separate sources 130. The first source 130 provides the following business information: (1) address: “1613 Chicago Ave. McAllen, Tex. 78501”, (2) telephone number: “956-213-8279”, and (3) business hours: “9 AM-9 PM Mon.-Sun.”; and the second source 130 provides the following business information: (1) address: “1613 Chicago Ave. McAllen, Tex. 78501”, (2) telephone number: “956-213-8778”, and (3) business hours: “11 AM-9 PM Mon.-Sun.”

The business information management server 110 retrieves 420 authority pages from authority websites 120 of the various business entities, and extracts 430 information from the retrieved authority pages. Continuing with the above example, the business information management server 110 retrieves the authority pages (e.g., the welcome page and/or the contact page) from the authority website 120 of the restaurant, and extracts 430 the following information: (1) address: “1613 Chicago Ave. McAllen, Tex. 78501”, and (2) telephone number: “956-213-8279”.

The business information management server 110 compares 440 the information extracted 430 from the authority pages with corresponding business information retrieved 410 from the aggregate information sources 130, and generates 450 accuracy scores for the entity-source pairs. Continuing with the above example, the business information management server 110 compares 440 the telephone numbers received from each source 130 with the extracted telephone number, compares 440 the received addresses with the extracted address, and generates 450 accuracy scores for the entity-source pairs of the restaurant and the first and second sources 130, respectively. Because the addresses of the restaurant from both sources 130 match the extracted address, the business information management server 110 assigns a relatively high accuracy score for both pairs (e.g., 0.6). Because the telephone number from the first source 130 matches the extracted telephone number, while the telephone number from the second source 130 does not match the extracted telephone number, the business information management server 110 boosts the accuracy score for the pair including the first source 130 (e.g., to 0.7) while reduces the accuracy score of the pair including the second source 130 (e.g., to 0.5). The business information management server 110 optionally generates reputation scores for the sources 130 based on the accuracy scores.

The business information management server 110 consolidates 460 the business information into collections of accurate business information for the variety of business entities based on the accuracy scores (and optionally the reputation scores). Continuing with the above example, the business information management server 110 generates a collection of accurate business information for the restaurant to include the following: (1) address: “1613 Chicago Ave. McAllen, Tex. 78501”, (2) telephone number: “956-213-8279”, and (3) business hours: “9 AM-9 PM Mon.-Sun.” Please note that the business hours are originally retrieved from the first source 130. The business information management server 110 selects the business hour information retrieved from the first source 130 and not the second source 130 because the accuracy score for the entity-source pair including the first source 130 is higher (e.g., 0.7) comparing to the accuracy score for the entity-source pair including the second source 130 (e.g., 0.5). Assuming, instead of providing the telephone number “956-213-8279”, the first source 130, like the second source 130, provides “956-213-8778”. In such a scenario, depending on the implementation configuration, the business information management server 110 may include both the telephone number from the sources 130 and the extracted telephone number in the collection as potentially accurate phone numbers, or include only the extracted telephone number (since it is more likely to be accurate).

The business information management server 110 outputs 470 the collections of accurate business information as requested. Continuing with the above example, if a user submits a query for business information about the restaurant, the business information management server 110 generates an output (e.g., as a webpage to be displayed to the user) including the collection of accurate business information.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for measuring the accuracy of business information from aggregate information sources using information extracted from authority websites and generating collections of accurate business information based on the accuracy measurements. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for generating accurate business information, comprising:
retrieving business information about a plurality of business entities from one or more aggregate information sources;
retrieving an authority page from an authority website of one of the plurality of business entities;
comparing business information about said business entity retrieved from the one or more aggregate information sources with information extracted from the authority page for a comparison result;
generating an accuracy score for a combination of said business entity and one of said aggregate information sources based at least in part on the comparison result; and
generating a collection of accurate business information for said business entity based at least in part on the accuracy score.

2. The method of claim 1, further comprising:
comparing the accuracy scores of said aggregate information sources for a second comparison result,
wherein generating the collection of accurate business information comprises including in the collection of accurate business information from aggregate information sources based at least in part on the second comparison result.

3. The method of claim 1, wherein generating the collection of accurate business information comprises including in the collection of accurate business information the information extracted from the authority page.

4. The method of claim 1, further comprising:
outputting the collection of accurate business information responsive to receiving an inquiry for said business entity.

5. The method of claim 1, wherein generating the accuracy score for the combination of said business entity and one of said aggregate information sources comprises:
responsive to the business information from an aggregate information source matching the information extracted from the authority page, generating a high accuracy score for a combination of said business entity and the aggregate information source; and
responsive to the business information from the aggregate information source matching the information extracted from the authority page, generating a low accuracy score for a combination of said business entity and the aggregate information source.

6. The method of claim 1, further comprising:
generating a reputation score for an aggregation information source based at least in part on the accuracy score for the combination of said business entity and the aggregation information source; and
generating a collection of accurate business information for a business entity without an authority website based at least in part on the reputation score.

7. A computer system for generating accurate business information, comprising:
a non-transitory computer-readable storage medium comprising executable computer program code for:
retrieving business information about a plurality of business entities from one or more aggregate information sources;
retrieving an authority page from an authority website of one of the plurality of business entities;
comparing business information about said business entity retrieved from the one or more aggregate information sources with information extracted from the authority page for a comparison result;
generating an accuracy score for a combination of said business entity and one of said aggregate information sources based at least in part on the comparison result; and
generating a collection of accurate business information for said business entity based at least in part on the accuracy score.

8. The computer system of claim 7, wherein the non-transitory computer-readable storage medium further comprises executable computer program code for:
comparing the accuracy scores of said aggregate information sources for a second comparison result,
wherein generating the collection of accurate business information comprises including in the collection of accurate business information from aggregate information sources based at least in part on the second comparison result.

9. The computer system of claim 7, wherein generating the collection of accurate business information comprises including in the collection of accurate business information the information extracted from the authority page.

10. The computer system of claim 7, wherein the non-transitory computer-readable storage medium further comprises executable computer program code for:
outputting the collection of accurate business information responsive to receiving an inquiry for said business entity.

11. The computer system of claim 7, wherein generating the accuracy score for the combination of said business entity and one of said aggregate information sources comprises:
responsive to the business information from an aggregate information source matching the information extracted from the authority page, generating a high accuracy score for a combination of said business entity and the aggregate information source; and
responsive to the business information from the aggregate information source matching the information extracted from the authority page, generating a low accuracy score for a combination of said business entity and the aggregate information source.

12. The computer system of claim 7, wherein the non-transitory computer-readable storage medium further comprises executable computer program code for:
generating a reputation score for an aggregation information source based at least in part on the accuracy score for the combination of said business entity and the aggregation information source; and
generating a collection of accurate business information for a business entity without an authority website based at least in part on the reputation score.

13. A non-transitory computer-readable storage medium storing executable computer program instructions for generating accurate business information, the computer program instructions comprising instructions for:
retrieving business information about a plurality of business entities from one or more aggregate information sources;
retrieving an authority page from an authority website of one of the plurality of business entities;
comparing business information about said business entity retrieved from the one or more aggregate information sources with information extracted from the authority page for a comparison result;
generating an accuracy score for a combination of said business entity and one of said aggregate information sources based at least in part on the comparison result; and
generating a collection of accurate business information for said business entity based at least in part on the accuracy score.

14. The storage medium of claim 13, wherein the computer program instructions further comprise:
comparing the accuracy scores of said aggregate information sources for a second comparison result,
wherein generating the collection of accurate business information comprises including in the collection of accurate business information from aggregate information sources based at least in part on the second comparison result.

15. The storage medium of claim 13, wherein generating the collection of accurate business information comprises including in the collection of accurate business information the information extracted from the authority page.

16. The storage medium of claim 13, wherein the computer program instructions further comprise:
outputting the collection of accurate business information responsive to receiving an inquiry for said business entity.

17. The storage medium of claim 13, wherein generating the accuracy score for the combination of said business entity and one of said aggregate information sources comprises:
responsive to the business information from an aggregate information source matching the information extracted from the authority page, generating a high accuracy score for a combination of said business entity and the aggregate information source; and
responsive to the business information from the aggregate information source matching the information extracted from the authority page, generating a low accuracy score for a combination of said business entity and the aggregate information source.

18. The storage medium of claim 13, wherein the computer program instructions further comprise:
generating a reputation score for an aggregation information source based at least in part on the accuracy score for the combination of said business entity and the aggregation information source; and
generating a collection of accurate business information for a business entity without an authority website based at least in part on the reputation score.
